(19) United States
(12) Patent Application Publication
(10) Pub. No.: US 2012/0189414 A1
(43) Pub. Date: Jul. 26, 2012

(54) LOADING ASSEMBLY FOR A RECEIVING CONTAINER

(76) Inventor: Darrell Louis Lukesic, Santo Domingo (DO)

(21) Appl. No.: 13/013,508

(22) Filed: Jan. 25, 2011

(51) Int. Cl. B60P 1/00; B65G 67/26

(52) U.S. Cl. 414/325; 414/349

(57) ABSTRACT

A loading assembly including a static or mobile frame having a platform adjustably supported thereon and a hopper for containment of material to be loaded being movable relative to the platform between a loading position and an unloading position. A positioning assembly is adjustably interconnected to the frame and cooperatively disposed and structured relative to the platform and hopper to facilitate disposition of the hopper between the loading and unloading positions. The positioning assembly is further structured to assume a retaining relation to the material initially loaded into the hopper and subsequently being unloaded from said hopper, concurrently to the movement of the hopper from the unloading position to the loading position.

### BACKGROUND OF THE INVENTION

1. Field of the Invention

This invention is directed to an assembly for loading bulk or other material into a receiving container and includes a hopper structured to facilitate collection of the material therein. The hopper is supported on and movable relative to an adjustable platform between a loading position, exteriorly of the container, and an unloading position on the interior of the container. A positioning assembly is structured to move the hopper from the loading position to the unloading position and thereafter maintain the material being loaded within the receiving container concurrently to positioning of the hopper back into the loading position on the platform.

2. Description of the Related Art

With the recent diversification and growth in the world steel and scrap market, suppliers have had to improvise ways to ship both type products to diverse destinations around the globe. Accordingly, shipping or transportation containers are being used extensively and in ever increasing numbers for the transportation of bulk material as well as other packaged or palletized material, to such destinations. As such, the majority of the shipping or transportation containers available, while varying in dimension or configuration, are typically of a common type structure. Such common structure commonly includes a closed top and a single access or entrance facility, such as one or more doors located at one end of the container. With such a conventionally recognized design for shipping and transportation containers, the methods of loading materials, particularly bulk materials of the type set forth above is difficult, especially in terms of being labor intensive and time consuming.

However, due to the transportation and delivery demands placed on suppliers, shipping and transport containers of the type indicated are gaining wide spread acceptance due, at least in part, to available cargo handling facilitates. As such, conventional shipping and transport containers may be effectively loaded onto various forms of transportation including railroad cars and large cargo carrying marine craft, etc. The sophisticated design and operation of cargo handling equipment such as van carriers, gantry hoists, traveling cranes, etc. facilitate the loading of the conventional cargo and shipping containers onto such forms of transportation. However, as set forth above, the conventional methods of loading such standardized containers include manual loading and/or the utilization of fork lifts and other types of loading equipment. Many of theses known methods due not overcome the disadvantages and problems associated with loading material, especially bulk material, into conventional shipping containers.

Additional disadvantages associated with the shipping and transport of various types of material, utilizing conventional shipping containers, relate to the accurate and efficient determination of the weight of such containers while being loaded. Therefore, if the cargo container and loaded material is not properly weighed on a timely basis, the container may have to be weighed numerous times subsequent completing the loading procedure in order to achieve an optimum cargo capacity. Such a failure to efficiently determine an accurate weight may result in increase in handling and time spent in order to effect a re-loading of the container. Therefore, in order to overcome such problems and disadvantages, numerous cargo and/or material loading systems have been devised to accomplish a more efficient loading procedure. However, a significant number of such known or conventional loading assemblies result in systems and/or procedures which are overly complex, expensive to obtain and operate and/or require the modification of the loading dock or station at which such conventional loading assemblies are operatively disposed. Attempts have been made to modify both the loading station and/or interior portions of the container. By way of example, conveyor-like assemblies have been added to shipping containers frequently requiring complex and expensive structural modifications to the loading dock or station, as well as the interior portions of the container. As a result, a variety of known or attempted loading devices have failed in their attempt to alleviate problems and disadvantages of the type generally set forth above.

Therefore, there is a need in this area for a loading assembly capable of effectively, efficiently and rapidly loading bulk and other type of material into the interior of a transport or shipping container in an automatic fashion, at least to the extent of eliminating or significantly reducing the requirement for manual labor as well as manually operated loading equipment. In addition, such a preferred loading assembly should include a frame which may be located at a fixed position or alternatively may define and/or be associated with a mobile vehicle. As such, disposition of the loading assembly in a preferred location as well as facilitating the orientation of the various components thereof in a sufficiently aligned relation with the container being loaded is thereby facilitated. In addition, such a preferred loading assembly should include accurate weight determining capabilities, wherein the material can be weighed during and prior to loading thereby eliminating the requirement for subsequent or repeated weight determination after loading procedure has been completed. Also, a proposed and preferred loading assembly should be capable of aligning the various operative components associated therewith with the position, orientation and overall structure of the shipping and/or transport container in which the materials are to be loaded. This adjustable alignment capability will significantly reduce the loading time resulting in an overall increase in efficiency regardless of the size and type of the shipping and transport container being loaded.

### SUMMARY OF THE INVENTION

The present invention is directed to an assembly for loading material, especially bulk material, into transportation or shipping containers of the type well known in the transportation industry. As such, the loading assembly of the present invention comprises a support frame which may be structured for disposition in a fixed location. Alternatively, the frame may define or be associated with a chassis of a tractor-trailer or other type vehicle. In this latter embodiment the support frame and the remaining operative components of the loading assembly can be easily transported to various loading sites which are easily accessible by the plurality of shipping containers to be loaded.

Moreover, a platform is movably or adjustably supported on the frame and is cooperatively structured therewith for adjustable orientation relative to the frame. A hopper is mounted on the platform and is adjustably positioned on the frame into an aligned orientation with the receiving container, so as to facilitate the loading thereof. In addition, the hopper may be structured to facilitate the collection of the bulk material to be loaded as well as facilitate the removal of the collected material from the interior of the hopper into the interior of the receiving container being loaded.

The loading procedure is accomplished, at least in part, by the operation of a positioning assembly interconnected and/or supported on the frame and operative to move the hopper into and between a loading position and unloading position. As set forth in greater detail hereinafter, the loading position of the hopper may be generally defined as its disposition on the platform in a position and orientation, which facilitates the deposit of material into the interior thereof. In contrast, the unloading position of the hopper may be accurately described as it being disposed at least partially on the interior of the transportation or receiving container at a location which facilitates the unloading of the material into the receiving container.

Accordingly, the positioning assembly is selectively operable to dispose the hopper between the loading position once having been loaded, and the unloading position at least partially on the interior of the receiving container being loaded. The structural and operative features of the positioning assembly also facilitate the movement of the hopper from the unloading position, at least partially within the container being loaded, into the loading position. This forced movement of the hopper from the unloading position to the loading position occurs concurrently to the positioning assembly being operative to remove the bulk material from the interior of the hopper and maintain it within the interior of the receiving container. Moreover, once the material is deposited within the receiving container, the appropriate portions of the positioning assembly assume their initial, operative position and/or orientation to receive the next load of bulk or other type material for loading into the next or subsequent receiving container.

Accordingly, the positioning assembly includes a first portion or sub-assembly preferably, but not necessarily, including an elongated extendable/retractable pusher arm. The arm is movable with the platform and is adjustable relative thereto so as to further facilitate the alignment of the hopper and the interior of the container during the loading procedure. This first portion of the positioning assembly also includes a retaining member or structure movably or adjustably connected to the pusher arm. The retaining member or structure may be in the form of a pusher plate, pusher block or like structure which corresponds, at least in part to the dimension and configuration of interior portions of the hopper. Moreover, the pusher arm and retaining structure or pusher block cooperate to displace the hopper from the loading position to the unloading position. In addition, the pusher arm and pusher block cooperate to unload the material from within the hopper into the interior of the receiving container concurrently to displacement of the hopper from the unloading position to the aforementioned loading position. Accordingly, a locking assembly is provided and mounted, at least partially on the retaining structure or pusher block. Further, the locking assembly is structured to removably interconnect the retaining member or structure to one open end of the hopper. As such, activation of the pusher arm will drive the pusher block, and the hopper connected thereto from the loading position into the unloading position. Once in the unloading position, the locking assembly will be activated to disconnect the pusher block or retaining structure from the hopper thereby allowing movement of the hopper relative to the retaining member or structure. Once the retaining member or structure is disconnected from the hopper, the structuring of a second portion of the positioning assembly will operate to displace the hopper from the unloading position to the loading position concurrently to the retaining member or structure forcing the material from the interior of the hopper into the interior of the receiving container. Other structural and operative features of one or more preferred embodiments of the loading assembly of the present invention include the provision of a scale assembly. The scale assembly is interconnected to the platform and/or frame and cooperatively associated therewith so as to provide an accurate weight of the hopper, while it is on the platform in the loading position, as the material is being deposited therein. In at least one embodiment, the scale assembly comprises a plurality of cells or weight determining structures distributed in spaced relation to one another about the platform and/or frame so as to provide an accurate determination of the weight of the hopper as the material to be loaded is being deposited therein. This has the affect of avoiding the time consuming and labor intensive necessity of repeatedly weighing the hopper subsequent to the loading procedure has been completed. A display assembly may be disposed in an appropriate location for observation in order to determine the weight of the material being loaded, thereby facilitating compliance with the weight of the load within the receiving container being loaded.

Accordingly, the loading assembly of the present invention overcomes many of the disadvantages and problems associated with known loading structures or devices, in manner which increases the overall efficiency of the loading procedure while reducing loading time, labor and costs.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a side view in partial schematic form of one preferred embodiment of the loading assembly of the present invention.

FIG. 2 is a side view similar to the embodiment of FIG. 1 wherein the loading assembly 10 is associated with a vehicle.

FIG. 3 is a top view in partial schematic form of the loading assembly, wherein a hopper component thereof is fully loaded.

FIG. 4 is a side view in partial schematic form of the embodiment of FIG. 3.

FIG. 5 is a side view in partial schematic form of the loading assembly, wherein the hopper is in a loading position.

FIG. 6A is rear plan composite view of a locking assembly of the present invention operable to selectively and removably lock the retaining structure to the hopper.

FIG. 6B is a composite end and front plan view of the embodiment of FIG. 6A.

FIG. 6C is a sectional view taken along lines 6c of FIG. 6B.

FIG. 7 is a top view of the loading assembly of the present invention in partial schematic form, wherein the hopper is disposed in an unloading position.

FIG. 8 is a side view in partial schematic form of the embodiment of FIG. 7.

FIG. 9 is a top view of the loading assembly of the present invention in partial schematic form, wherein the material is being deposited within a receiving container as the hopper is moved from a loading position to an unloading position.

FIG. 10 is a side view of the embodiment of FIG. 9.

FIG. 11 is a top view in partial schematic form of the loading assembly of the present invention, wherein the hopper is moved into the loading position from the unloading position.

FIG. 12 is a side view of the embodiment of FIG. 11.

FIGS. 13 and 14 are top views in partial schematic form of the loading assembly of the present invention representing selective adjustment of the positioning assembly relative to the platform and/or frame of the loading assembly.

FIG. 15 is a side view in partial schematic form of the loading assembly of the present invention wherein the hopper is being disposed from the loading position to an unloading position in a receiving container which is oriented at a different level than the platform and/or frame of the loading assembly.

FIG. 16 is a top view in partial schematic form of the loading assembly of the present invention being aligned with a receiving container.

FIG. 17 is a side view in partial schematic form of the embodiment of FIG. 16, wherein a securement assembly and flexible interface thereof is established between the loading assembly of the present invention and the receiving container.

FIG. 18 is a perspective view in partial schematic form of the retaining structure of the present invention.

FIG. 19 is a perspective view in partial schematic form of the embodiment of FIG. 18 comprising a confronting portion disposed in outwardly extended position.

FIG. 20 is a side view of the loading assembly of the present invention incorporating the embodiment of the retaining structure as represented in FIGS. 18 and 19, wherein the retaining structure is in a retaining orientation.

Like reference numerals refer to like parts throughout the several views of the drawings.

### DETAILED DESCRIPTION OF THE PREFERRED EMBODIMENT

As shown in the accompanying Figures, the present invention is directed to a loading assembly, generally indicated as 10, structured for loading material into a receiving container which could take the form of a shipping or transportation container, as schematically represented as 12. While the loading assembly 10 is specifically structured for loading bulk material into the receiving container 12, a variety of other types of material can also be loaded. Accordingly, the loading assembly 10 includes a hopper generally indicated as 14 having an open top which facilitates the material 15 being deposited therein by any of a plurality of procedures and/or equipment, including those which are known in the loading industry.

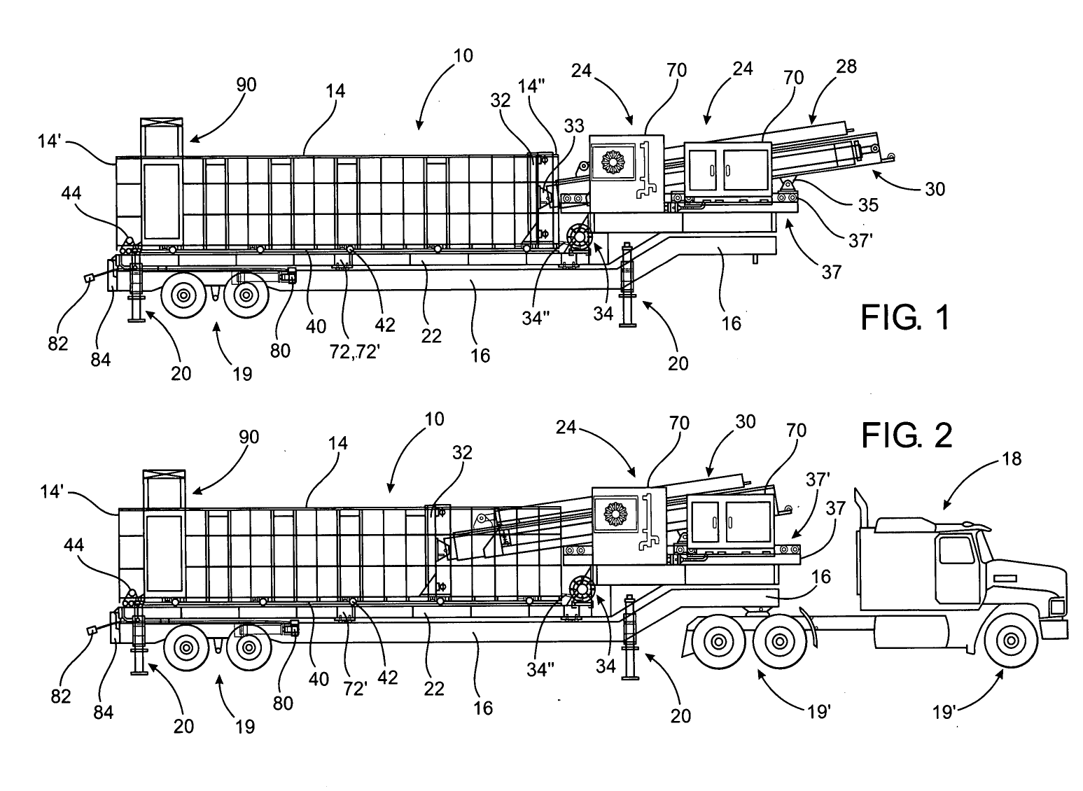

Moreover, the loading assembly 10 includes a frame 16 which, as represented in FIGS. 1 and 2, may be substantially permanently disposed at a loading site as represented in FIG. 1. Alternatively, the frame 16 may at least partially define or be part of a chassis associated with a vehicle, generally indicated as 18 in FIG. 2, such as a tractor-trailer type vehicle. When a frame 16 is part of a vehicle chassis, it may be efficiently transported to any of a plurality of different loading sites where the shipping or transportation containers 12 are intended to be loaded. In either the fixed or vehicular embodiment, the frame 16 may include wheels or running gear 19, structured for limited or extensive movement or travel. In addition, a plurality of stabilizers 20 are connected to the frame 16 and operatively positioned to stabilize the overall loading assembly 10 once it is located at a given loading site.

The loading assembly 10 of the present invention further comprises a platform 22 supported on the frame 16 and movable therewith, as generally set forth above. In addition, the platform 22 is adjustable relative to the frame 16 in order to assure and/or facilitate alignment of the hopper 14 with the receiving container 12 being loaded, as set forth in greater detail hereinafter. In addition, an operator area and/or control area 24 is connected to the frame 16 or otherwise disposed in cooperation therewith. As such, one or more operators, as required, may be positioned to view the loading procedure as well as activate appropriate control equipment for activating the various operative components of the loading assembly 10.

The loading assembly 10 also includes a positioning assembly generally indicated as 28 including an elongated, pusher arm 30 pivotally and/or otherwise adjustably connected to a retaining member or structure 32 in the form of a “pusher plate” or “pusher block”. As such, the pusher arm 30 and retaining member or structure 32 may be described as defining a first portion of the positioning assembly 28. A second portion of the positioning assembly 28 is generally indicated as 34 and comprises a winch such as, but not limited to, a hydraulic cylinder type winch connected to the hopper 14, as at 34′, by an appropriate cable, line or other appropriate structure.

As represented, the pushing arm 30 includes an elongated configuration preferably, but not necessarily, including a plurality of arm segments 30′ movable relative to one another in a telescopic fashion. Accordingly, the pusher arm 30 is structured for extension or retraction and is connected to the retaining member 32 to facilitate movement of the hopper 14 from the loading position into the unloading position. In addition, the pushing arm 30 is adjustable relative to the retaining member or structure 32 by a pivotal connection thereto as at 33. This pivotal and/or other appropriate, adjustable connection 33 allows relative movement of the corresponding end of the pusher arm 30 and the retaining member 32 as the hopper 14 is forced from the loading position into the unloading position.

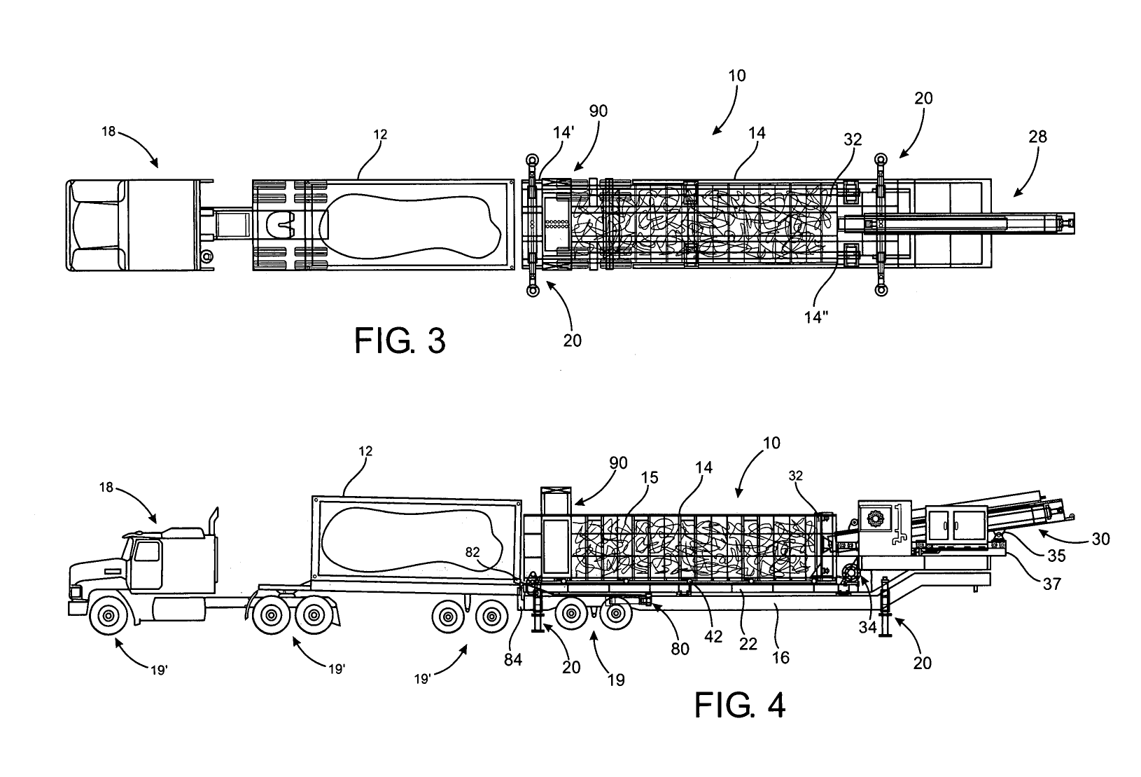

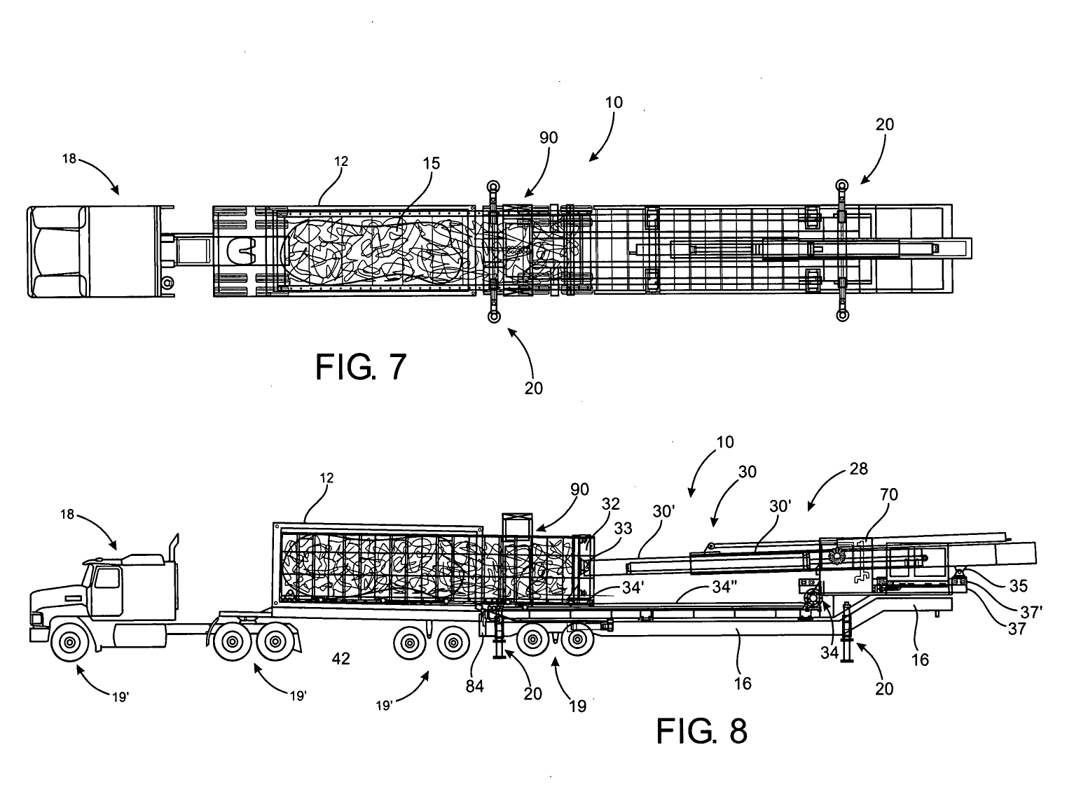

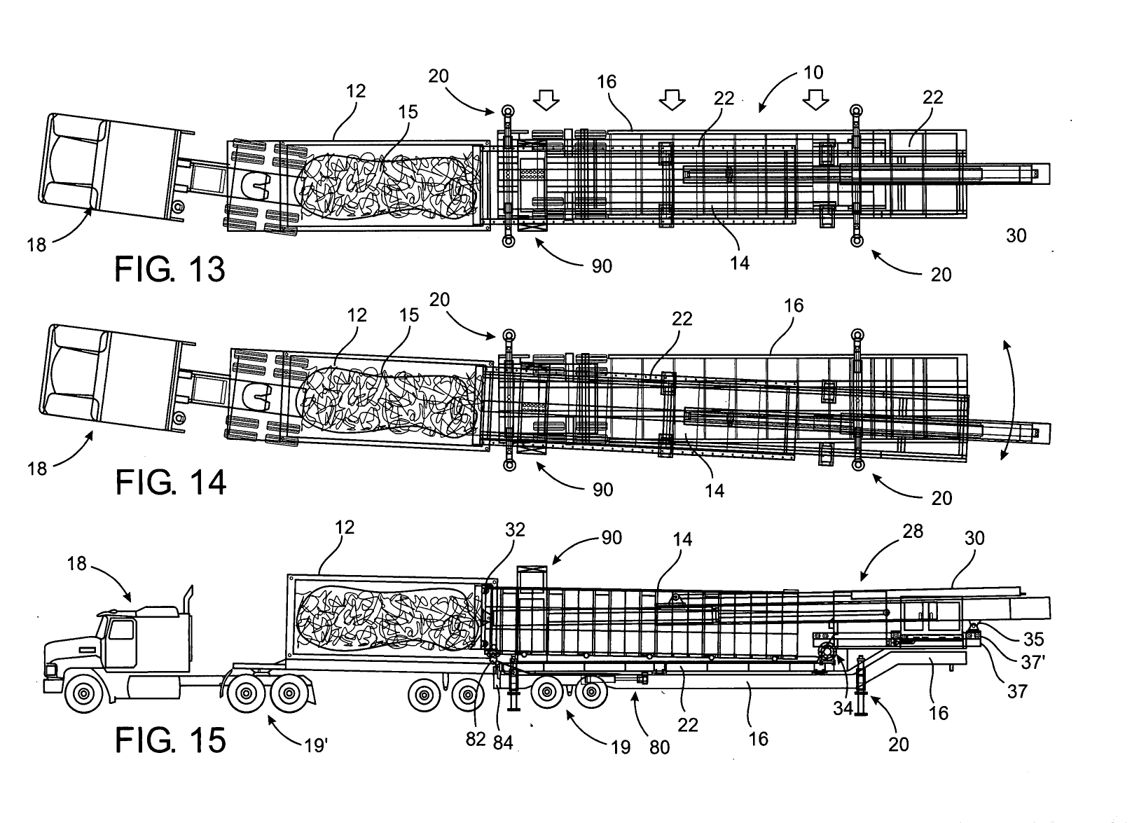

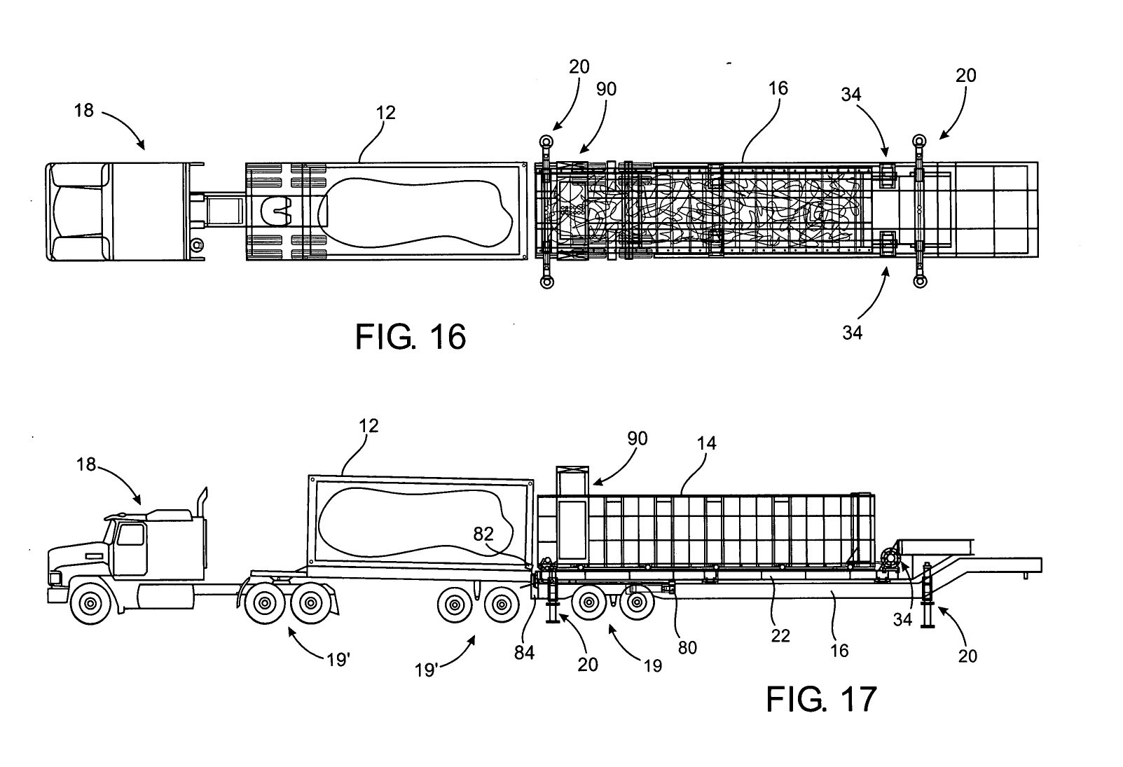

Adjustable interconnection of the pushing arm 30 relative to the platform 22 is also accomplished by a pivotal or otherwise adjustable interconnecting assembly generally indicated as 35. With primary reference to FIG. 3, the adjustable interconnection 35 may also facilitate a lateral adjustment of the pusher arm 30 relative to the platform 22, by means of a roller or other movable support defining or connected to the base of the adjustable interconnection 35, as at 35′. Therefore, the pusher arm 30 is capable of moving and/or being adjusted laterally relative to the platform 22 and is also movably or adjustably attached to the retaining member or structure 32, so as to further facilitate alignment and/or disposition of the hopper 14 with and into the receiving container 12 when moving from the loading position to the unloading position. In addition, a significant portion of the pusher arm is disposed on the platform 22, which is adjustably supported on an end most section of the frame, such as beneath the adjustable connection 35. These corresponding end portions of the frame and platform are structured to at least partially define an “extension guide” portion of the frame 16 and platform 22. As such, the extension guide allows for appropriate extension, retraction and/or disposition of the pusher arm 30 so as to facilitate the proper placement of the hopper 14 and the unloading of the material 15 therefrom into a receiving or transportation container 12 having a greater or extended length. Therefore, the first portion 30, 32 of the positioning assembly 28, as well as the second portion 34 thereof, are cooperatively structured and operative to selectively dispose the hopper 14 into and between both a loading position, as represented in FIGS. 1-5, and an unloading position, as represented in FIGS. 7 and 8. More specifically, the loading position of the hopper 14 is at least partially defined by it being disposed on the platform 22. When in the loading position, the hopper 14 is disposed to receive the bulk or other material 15 therein. Thereafter, once the hopper 14 is at least partially loaded, it is moved on and relative to the platform 22 from the loading position to the unloading position. In addition, the hopper 14 may be moved with the platform 22, relative to the frame 16, in order to properly dispose the hopper 14 into a substantially aligned orientation, which facilitates its passage into the interior of the receiving container 12, as at least partially represented in FIG. 13-15.

More specifically, the structural interconnection which serves to mount or otherwise connect the platform 22 to the frame 16 allows the platform 22 to be laterally and/or angularly (radially) adjustable relative to the frame 16 so as to at least partially dispose the platform 22 into a preferred, aligned orientation relative to the receiving container 12. As set forth above, in order to accomplish the preferred alignment with the receiving container 12, the hopper 14, at least when it is in the loading position, may also move with the platform 22 relative to the frame, in that the platform 22 is laterally and/or angularly adjustable relative to the frame 16, as schematically indicated by directional arrows throughout some of the accompanying Figures. This in turn will accomplish a substantially linear or axial alignment of the hopper 14 with the interior of the receiving container 12. Such linear or axial alignment will provide for a more efficient placement of the hopper 14 as it is moved into the unloading position within the container 12 due to activation of the pushing arm 30 into driving engagement with the retaining member or pusher block 32. As also represented in FIGS. 13-15 upper and lower support pads or like structure 72′ may be disposed and structured to facilitate lateral and angular (radial) movement of the platform 22 relative to the frame 16 in order to accomplish the preferred and appropriate alignment between the hopper 14 and the interior of the receiving container 12 as the hopper 14 is moved from the loading position to the unloading position within the receiving container.

As will also be explained with specific reference to FIG. 6, a locking assembly 50 is provided to facilitate a locked and unlocked connection of the retaining member or structure 32 with a corresponding end of the hopper 14. Other features associated with the loading assembly 10 include an appropriate track structure 40 disposed on the platform 22 and structured to engage supporting rollers or wheels 42 connected to the under carriage of the hopper 14. Therefore, movement of the hopper 14 into and between the loading and unloading positions, as described above, is facilitated by the support wheel assembly 42 rolling on and along the length of the rails 40. Also, the hopper 14 may include guide wheel assembly 44 connected at least to the leading end 14′ thereof on or about the under carriage. The guide wheels 44 are disposed and structured to facilitate placement of the hopper 14 into a shipping container 12, which may be disposed at a raised or lowered orientation relative to the platform 22 and/or frame 16, as represented in FIGS. 4 and/or 17.

Another structural and operative feature of the loading assembly 10 facilitates the alignment and/or at least temporary interconnection between the frame 16 and/or platform 22 in an area adjacent to the leading end 14′ of the hopper 14. More specifically, a securement assembly generally indicated as 80, includes a flexible, interface locking mechanism 82 which is powered to at least partially engage and maintain the junction or interconnected disposition of corresponding ends of the receiving chamber 12 and the platform 16. In addition, a stop member or like structure 84 is disposed on the frame 16 in a location which serves to engage a trailing end of the receiving container 12 and/or the frame of the vehicle 18 on which it is mounted. As such, the securement assembly 80 may be appropriately powered such as hydraulically, pneumatically, mechanically, etc. to dispose the flexible lock and/or interface 82 into removable but stable engagement with the corresponding end of the receiving container 12 upon selective activation thereof.

Yet additional structural and operative features associated with at least some of the preferred embodiments of the loading assembly 10 include the provision of a radiation detection system generally indicated as 90. As such, the radiation detection system 90 may include a multi-panel construction and be disposed relative to an appropriate portion of the hopper 14 and the material 15 loaded therein. As such, the radiation detection system 90 is disposed to detect any potentially harmful or dangerous radiation material and/or weaponry during or prior to the material 15 being loaded within the interior of the container 12.

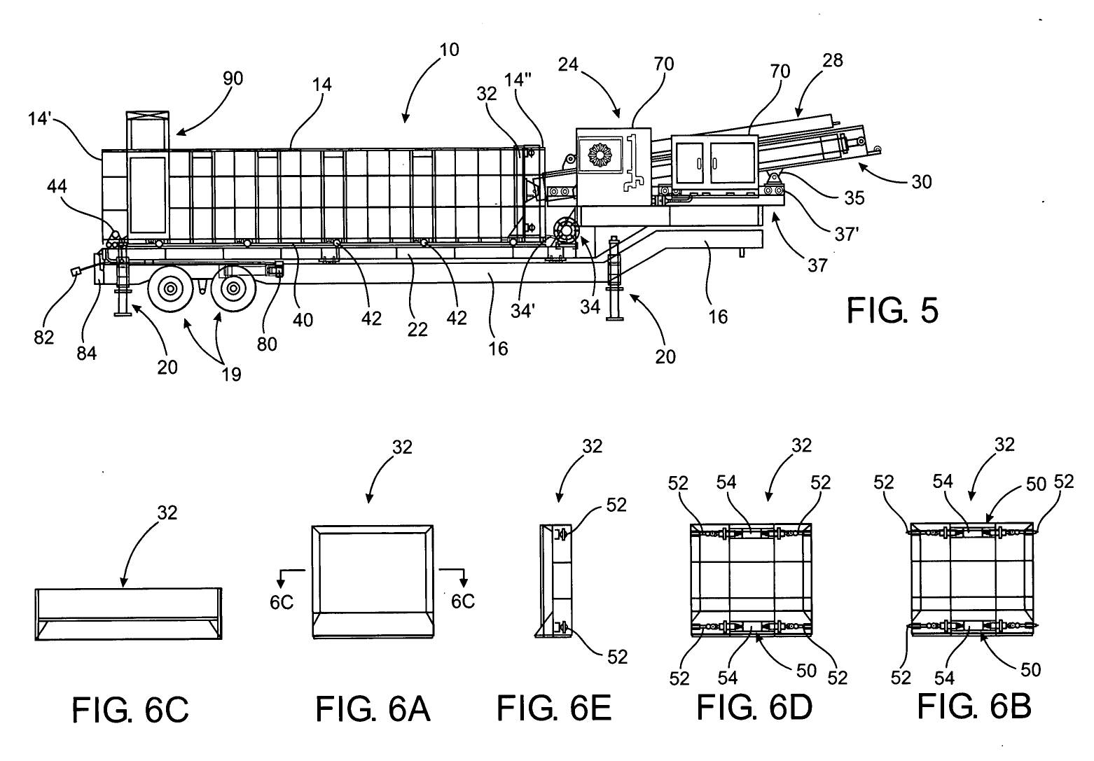

With reference to FIGS. 5 and 6, the pusher arm 30 and the retaining member 32 of the positioning assembly 28 serve to move the hopper 14 from the loading position, represented in FIGS. 5 and 6, into the unloading position, represented in FIGS. 7 and 8. In order to facilitate such movement of the hopper 14, the aforementioned locking assembly 50, as represented in FIGS. 6A and 6B, is disposed and structured to removably lock or connect the retaining member 32 to the end 14″ of the hopper 14. Moreover, the locking assembly 50 comprises a plurality of locking pins, as at 52, which may be activated by mechanical or hydraulically powered linkage 54, to selectively dispose the plurality of pins 52 into and out of a removable but stable, locking interconnection between the retaining member 32 and the corresponding sides or other appropriate portions of the corresponding end 14″ of the hopper 14. In the embodiment of FIG. 6A, activation of the locking assembly 50 causes the pins 52 to establish the interlocking engagement between the retaining member or structure 32 and the hopper 14. Therefore, when the locking assembly 50 is disposed to interconnect the retaining member or structure 32 and the hopper 14, a driving force, schematically represented as 47, will be placed on the retaining member 32 by activation of the pushing arm 30. Due to its locked connection, by the locking assembly 50, the retaining member 32 will force the hopper 14 from the loading position of FIG. 5 into the unloading position of FIGS. 7 and 8, at least partially within the shipping container 12. Once in the unloading position, the locking assembly 50 will be activated to the extent of removing the pins 52 from their locked orientation between the retaining member 32 and the hopper 14, thereby disconnecting the retaining member or structure 32 from the hopper 14.

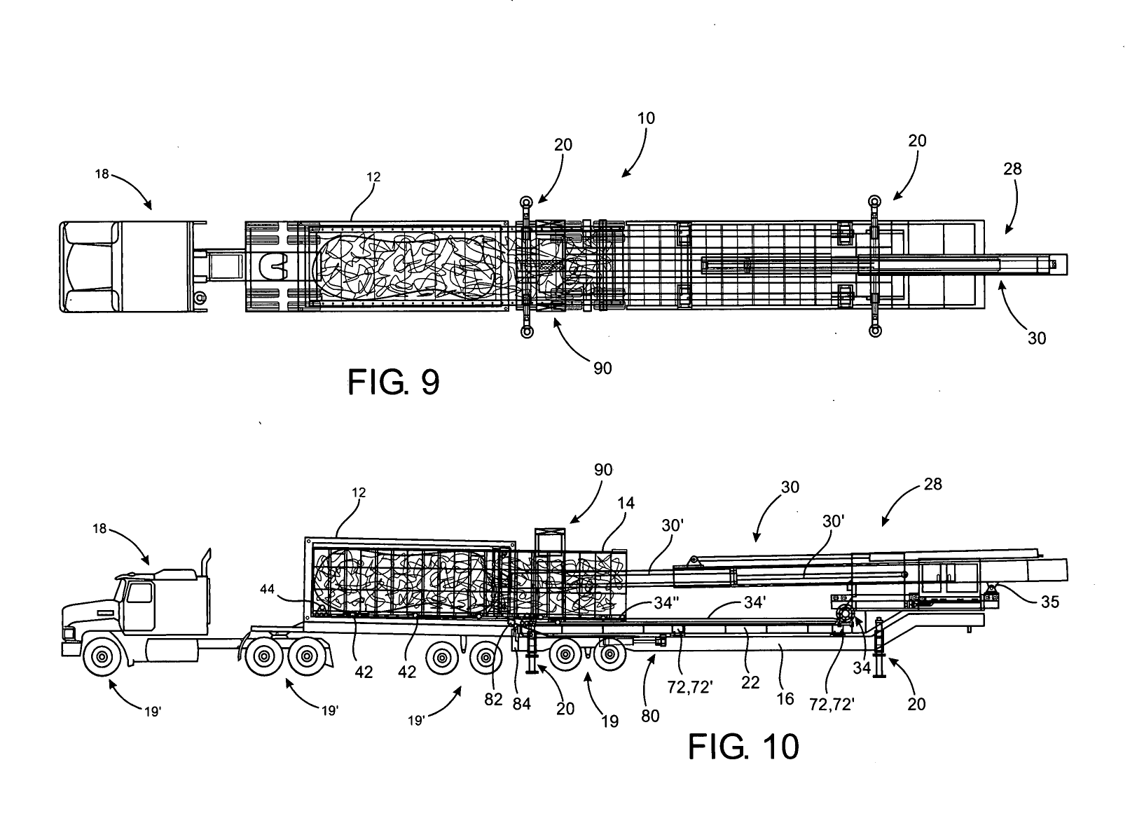

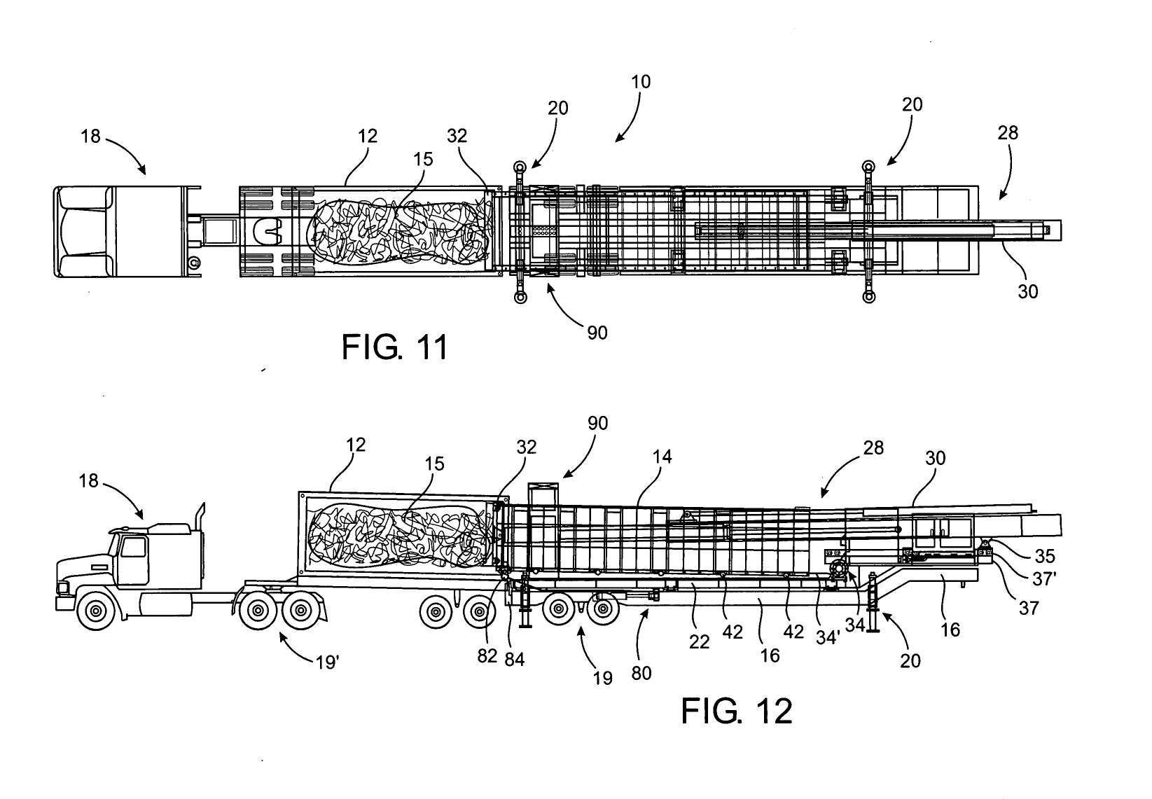

With reference to FIGS. 9 and 10, once the retaining member 32 is unlocked from the hopper 14, the second portion or cooperative sub-assembly 34 of the positioning assembly 28, in the form of a winch or other structure, will be activated. Due to the interconnection 34′ between the winch 34 and the hopper 14, the hopper 14 will be pulled back from the unloading position of FIGS. 9 and 10 into the loading position represented in FIGS. 11 and 12. Therefore, one feature of the present invention is the structure and operation of the positioning assembly 28, which concurrently moves the hopper 14 back into the loading position from the unloading position, while the retaining member or pusher block 32 is advanced or maintained in a retaining relation to the material 15, initially disposed within the hopper 14. More specifically, once the retaining member or structure 32 is disconnected from the end 14″ of the hopper 14, the hopper 14 is free to move back into the loading position, upon activation of the winch 34. Concurrently, the pushing arm 30 will remain extended, causing the retaining member 32 to be disposed in retaining relation to the material 15 and force the material out of the end 14′ of the hopper 14 as the hopper 14 is moved back into the loading position. As a result, the material 15 will be retained within the interior of the receiving or receiving container 12.

It is of further note that the end 14′ is structured to open during passage of the material 15 there through into the interior of the shipping container 12. However, the end 14′ is normally in a closed orientation, when the hopper 14 is in the loading position and the material 15 is deposited therein. As a result, the hopper 14 will be concurrently moved from the unloading position, within the shipment container 12, to the loading position, on the platform 22, while the material 15 is being forced out of the open end 14′ of the hopper 14 so as to be maintained within the interior of the shipment container 12. Once the material 15 is disposed and retained within the receiving or shipping container 12 and the hopper 14 is in the loading position of FIGS. 11 and 12, the positioning arm 30 and the retaining member 32 will again be retracted into the loading position, wherein the retaining member or structure 32 is disposed adjacent the end 14″ of the hopper 14. With the hopper 14 and the positioning assembly 28 in the loading position, the locking assembly 50 will again be activated so as to removably but reliably interconnect the retaining member 32 to the corresponding end 14″ of the hopper 14.

As generally set for the above, other features of the loading assembly 10 include the provision of the platform 22 being laterally adjustable relative to the frame 16. This may be accomplished through the provision of adjustable supports located at least at the forward end and rearward end of the platform 22 wherein these adjustable connections serve to adjustably and movably support the platform 22 on the frame 16. Various adjustable mounting or support structures can be utilized to accomplish this support and lateral adjustment of the platform 22 relative to the frame 16. Further, the plurality of adjustable, movable supports may be operated or powered by hydraulics, mechanical, electromechanical or pneumatic linkage, etc. as best fits a specific application of the loading assembly.

Additional features of the loading assembly 10 are represented in FIG. 9 wherein a source of operating power such as, but not limited to, an electric, hydraulic or pneumatic power unit 60 may be mounted on, connected to or otherwise disposed in operative relation to the operator or control area 24 and/or a remainder of the frame 16 and/or platform 22.

Other structural and operative features of one or more preferred embodiments of the loading assembly of the present invention include the provision of a scale assembly. The scale assembly is interconnected to the platform 22 and/or frame 16 and is cooperatively associated therewith so as to provide an accurate weight of the hopper 14, while it is on the platform 22 in the loading position and as the material 15 is being deposited therein. In at least one embodiment, the scale assembly comprises a plurality of cells or weight determining structures 72 disposed in spaced relation to one another about the platform 22 and/or frame 16 so as to provide an accurate determination of the weight of the hopper 14 as the material 15 is being deposited therein. In addition, a display assembly may be disposed in an appropriate location for observation in order to indicate the weight of the material 15 and/or hopper 14. Compliance of any weight restrictions of the loaded shipping container is thereby assured. Moreover, upper and lower support pads or like structure 72′ may be disposed adjacent to or independent of the cells 72, wherein the pads 72′ are disposed and structured to facilitate lateral and radial movement of the platform 22 relative to the frame 16 as described in greater detail with regard to the structure of FIGS. 13-15.

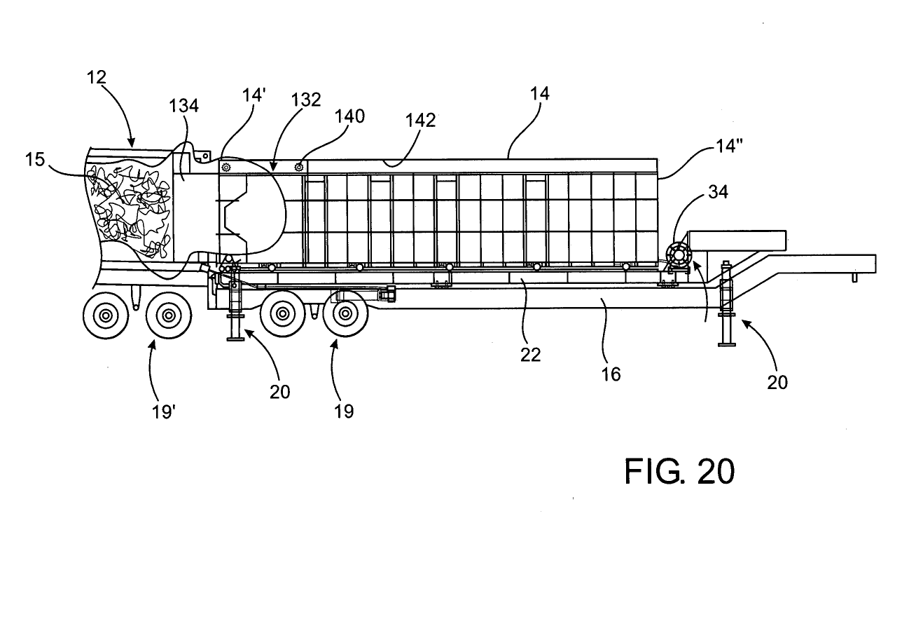

Yet another preferred embodiment of the loading assembly incorporates a retaining structure generally indicated as 132. The retaining structure 132 operates as a pushing block or like structure which, as represented in FIG. 20, is selectively disposed to assume a retaining orientation, wherein a confronting portion 134 is disposed in confronting, retaining relation to the material 15, when the retaining structure 132 is at least partially within the retaining orientation. In addition, in at least one embodiment represented in FIGS. 19-20, the retaining structure 132 is at least partially or entirely self contained at least to the extent of including a self-contained power source. Moreover, the power source may be located on the retaining structure 132 such as within the interior thereof, as at 136. The power source (not shown for purposes of clarity) may be an electrical power source and be operatively interconnected with appropriate cables, conductors, etc. to a drive assembly generally indicated as 138.

The drive assembly 138 may comprise a plurality of gears such as, but not limited to, pinion gears 140 appropriately disposed on the retaining structure 132. The inclusion and operation of the drive assembly 138 and the plurality of gears 140 at least partially defines a driving interconnection of the retaining structure 132 on and within the hopper 14 as also represented in FIG. 20. The plurality of pinion gears or other appropriate gearing assembly 140 is disposed to selectively drive the retaining structure 132 within and along the length of the hopper 14 from the end 14′, associated with the receiving container 12, towards and in substantial alignment with the end 14″ opposite to the receiving chamber 12. The aforementioned driving interconnection is accomplished by the plurality of pinion gears meshing with and riding along a track or guide structure 142 mounted on and/or at least partially within the interior of the hopper 14. Accordingly, the track, guide, 142 may be in the form of a rack gear or otherwise appropriately structured to cause a driving interaction and/or meshing engagement with the driven gears 140 upon activation of the drive assembly 138. The powering of the drive assembly 138 may occur by the self-contained electrical power source, such as may be disposed within the interior 136, of the retaining structure 132.

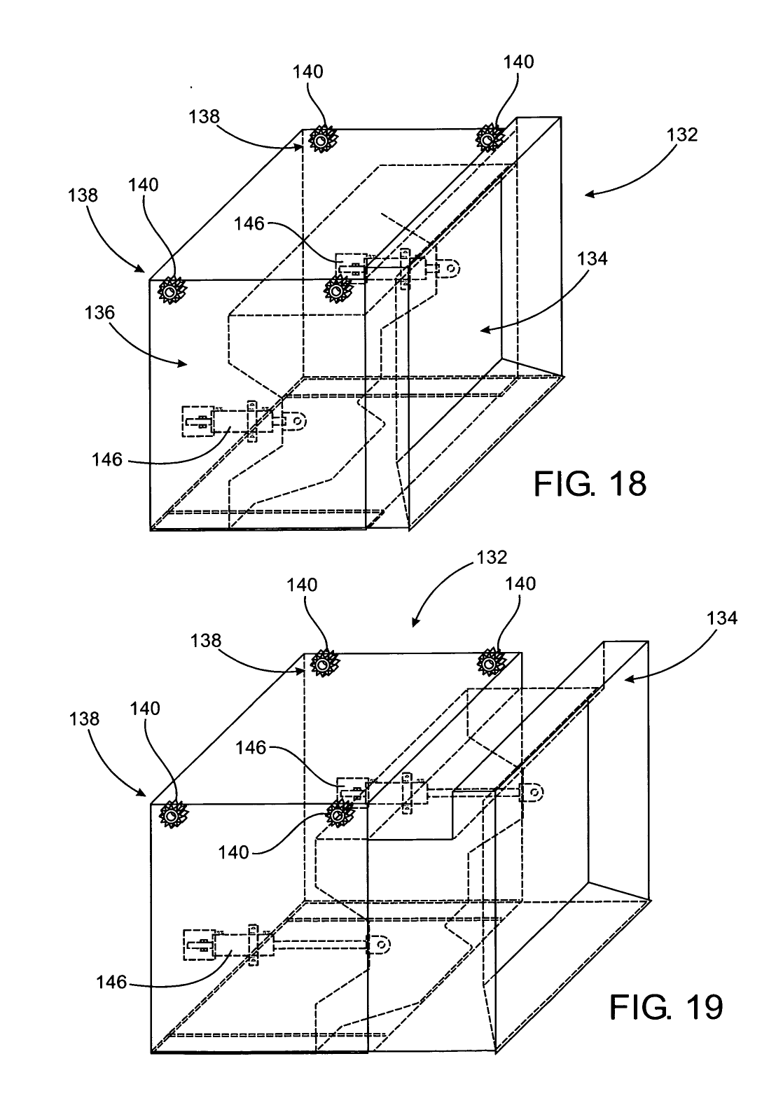

Additional structural features represented in FIGS. 18 and 19 include the aforementioned confronting portion 134. Accordingly, when the retaining structure 132 is in the retaining orientation as represented in FIG. 20, further activation of the self-contained power source will in turn activate linkage 146 to selectively dispose the confronting portion 134 in an outwardly extended position, as indicated in FIG. 19. Moreover, as the retaining structure 132 facilitates the loading of the material 15 into the receiving container 12, the confronting portion 134 will be retracted back into the orientation represented in FIG. 18. Such retraction may occur before, during or subsequent to the retaining structure 132 being removed from the interior of the receiving container 12 and passing along the interior of the majority of the length of the hopper 14, into substantial alignment and/or adjacent relation to the opposite end 14″.

As should be apparent, the retaining structure 132 will be disposed in adjacent and/or aligned relation with the end 14′ when the hopper 14 is in the unloading orientation of FIG. 20. Therefore, upon the withdrawal or retraction of the hopper 14 from the interior of the container 12, the drive assembly 138, 140 will be activated to drive the retaining structure 132 relative to the hopper 14, such that it will maintain its retaining orientation relative to the material 15 being unloaded, as represented in FIG. 20. Once the unloading of the material 15 into the receiving container 12 is complete, the driving assembly 138, 140 will again be activated to facilitate travel or movement of the retaining structure 132 from the retaining orientation of FIG. 20, along substantially the entire or majority of the length of the hopper 14 and within the interior thereof into alignment with the opposite end 14″. It is therefore an operative feature of the embodiment of FIGS. 18-20 to eliminate the use of the pushing assembly 28 in the form of the elongated pushing arm 30 as described in detail above with regard to the embodiment of FIGS. 1-15.

Accordingly, in the embodiments of FIGS. 18-20, the power winch 34 at least partially defining the aforementioned second portion of the positioning assembly 128 will be interconnected to the hopper 14 so as to selectively position it, relative to the platform 22 and frame 16, both into and out of the interior of the receiving container 12. As set forth above in detail, when the hopper 14 is disposed within the interior of the container 12 it is in its unloading position. When so positioned, the self-contained retaining structure 132 is driven or as otherwise allowed to “free-wheel” relative to the interior of the hopper 14, due to the interaction of the gears 140 and track or guide 142. In either event, the retaining structure 132 will be maintained in the retaining orientation, as represented in FIG. 20, as the hopper 14 is retracted back from the interior of the container 12 into the loading position as represented in FIG. 20.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. An assembly for loading material into a receiving container, said assembly comprising:
a frame and a platform mounted thereon, said platform movably connected for adjustable orientation relative to said frame,
said loading position defined by said hopper disposed sufficiently out of the receiving container to facilitate placement of the material within said hopper,
said unloading position defined by said hopper being disposed at least partially within the receiving container,
a positioning assembly interconnected in supported relation to said frame and structured to movably dispose said hopper relative to said platform into and between said loading and unloading positions,
said retaining orientation comprising said retaining structure disposed to retain the material within the receiving container concurrently to movement of said hopper from said unloading position to said loading position, and
said positioning assembly further including at least a second portion structured for placement of said hopper at least from said unloading position to said loading position concurrently to said first portion being disposed in said retaining orientation relative to the material within the container.

2. An assembly as recited in claim 1 wherein said first portion of said positioning assembly further comprises a pusher assembly, said retaining structure connected to said pusher assembly; said pusher assembly and said retaining structure collectively structured to displace said hopper on said platform from said loading position to said unloading position.

3. An assembly as recited in claim 2 wherein said pusher assembly is structured to maintain said retaining structure in said retaining orientation relative to the material within the receiving container concurrent to movement of said hopper from said unloading position to said loading position.

4. An assembly as recited in claim 2 further comprising a locking assembly disposed in removable interconnecting relation between said retaining structure and said hopper at least during movement of said hopper from said loading position to said unloading position.

5. An assembly as recited in claim 4 wherein said pusher assembly is disposed in driving relation to both said retaining structure and said hopper during interconnection of said retaining structure and said hopper concurrently to movement of said hopper from said loading position to said unloading position.

6. An assembly as recited in claim 4 wherein said retaining orientation further comprises said locking assembly disposed in disconnecting relation between said retaining structure and said hopper upon said movement of said hopper from said unloading position into said loading position.

7. An assembly as recited in claim 2 wherein said pusher assembly is adjustably disposed on said platform.

8. An assembly as recited in claim 7 wherein said pusher assembly is vertically and laterally adjustable relative to said platform to facilitate a loading alignment between said hopper and the receiving container.

9. An assembly as recited in claim 8 wherein said pusher assembly and said retaining structure are adjustably connected to one another and are adjustably disposable relative to said platform to facilitate a loading alignment of said hopper with the receiving container from said loading position to said unloading position.

10. An assembly as recited in claim 1 wherein said support frame is structured to define a portion of a mobile vehicle, said support frame and platform selectively disposable with the vehicle into a loading orientation relative to the container being loaded.

11. An assembly as recited in claim 1 wherein said platform is laterally adjustable on said frame to facilitate substantial alignment of said hopper, when in said loading position, with the container being loaded.

12. An assembly as recited in claim 11 wherein said hopper is laterally movable with said platform relative to said frame at least when said hopper is in said loading position.

13. An assembly as recited in claim 1 wherein said pusher assembly comprises a pusher arm structured for extended and retracted, variable length disposition to respectively define said loading and unloading positions of said hopper.

14. An assembly as recited in claim 1 wherein said retaining structure is movable within and relative to said hopper and includes a drive assembly and a power source collectively structured to drivingly interconnect and movably dispose said retaining structure along a length of said hopper.

15. An assembly as recited in claim 14 wherein said power source is self contained on said retaining structure.

16. An assembly as recited in claim 14 further comprising a confronting portion movably connected to a remainder of said retaining structure and selectively disposable in an extended, material confronting orientation at least when said retaining structure is in said retaining orientation.

17. An assembly as recited in claim 16 wherein said confronting portion is dimensioned and disposed to pass at least partially into said the receiving container when in said extended, material confronting orientation.

18. An assembly as recited in claim 14 wherein said drive assembly and power source are collectively structured to facilitate selective disposition of said retaining structure along at least a majority of a length of said hopper from said retaining orientation towards an end of said hopper opposite the receiving container, at least when said hopper is in said loading position.

19. An assembly as recited in claim 1 wherein said retaining structure comprises a confronting portion disposable in confronting relation to the material, at least when said retaining structure is in said retaining orientation, said confronting portion including an outer peripheral structure configured to direct the material into the receiving container.

20. An assembly as recited in claim 19 wherein said peripheral structure comprises a substantially wedged shaped sectional configuration extending along at a least majority of a length of said peripheral portion.

21. An assembly for loading material into a receiving, transportation container, said assembly comprising:
a frame,
a platform movably connected to said frame and cooperatively structured therewith for substantial loading alignment with the container,
a hopper disposed on said platform and movable therewith into said substantially loading alignment with the container,
said hopper structured for movement relative to said platform between a loading position and an unloading position,
a positioning assembly interconnected to said frame and cooperatively disposed and structured with said hopper to dispose said hopper into and between said loading and unloading positions,
said retaining structure further structured to assume a retaining orientation relation to the material within the container concurrently to movement of said hopper from said unloading position to said loading position, and
said retaining structure movable within and relative to said hopper and including a drive assembly and a power source self contained on said retaining structure and collectively operable to drivingly interconnect and movably dispose said retaining structure along a length of the interior of said hopper.

22. An assembly as recited in claim 21 further comprising a confronting portion movably connected to a remainder of said retaining assembly and selectively disposable in an extended, material confronting orientation at least when said retaining structure is in said retaining orientation.

23. An assembly as recited in claim 22 wherein said confronting portion is dimensioned and disposed to pass at least partially into the receiving container when said confronting portion is in said extended, material confronting orientation.

24. An assembly as recited in claim 21 wherein said drive assembly and power source are collectively structured to facilitate selective disposition of said retaining structure along at least a majority of a length of said hopper from said retaining orientation towards an end of said hopper opposite the receiving container, at least when said hopper is in said loading position.

25. An assembly as recited in claim 21 wherein said retaining structure comprises a confronting portion disposable in confronting relation to the material, at least when said retaining structure is in said retaining orientation, said confronting portion including an outer peripheral structure configured to direct the material into the receiving container.

26. An assembly as recited in claim 25 wherein said peripheral structure comprises a substantially wedged shaped sectional configuration extending along at a least majority of a length of said peripheral portion.
